(19) United States
(12) Patent Application Publication
(10) Pub. No.: US 2005/0228095 A1
(43) Pub. Date: Oct. 13, 2005

(54) Polyarylene sulfide resin composition and molded article therefrom

(75) Inventors: Katsuhei Onishi, Fuji-shi (JP); Hirohito Kawama, Iwaki-shi (JP); Kouichi Suzuki, Iwaki-shi (JP); Hiroyuki Sato, Iwaki-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignees: Polyplastic Co., Ltd.,, Tokyo (JP); Kureha Chemical Industry Company, Limited, Tokyo (JP)

(21) Appl. No.: 11/092,569

(22) Filed: Mar. 29, 2005

(30) Foreign Application Priority Data
Apr. 12, 2004 (JP) 2004-116530

(51) Int. Cl. C08K 3/26; C08K 3/34

(52) U.S. Cl. 524/425; 524/445

(57) ABSTRACT

The invention provides a polyarylene sulfide resin composition which can be molded with remarkably reduced trouble of mold-deposit and is improved in thermal stability. The composition contains (A) 100 parts by weight of a polyarylene sulfide resin having a nitrogen element content of 0.55 g or less per 1 kg of the resin and (B) 5-400 parts by weight of an inorganic filler.

### TECHNICAL FIELD

The present invention relates to a polyarylene sulfide resin composition which can be molded with remarkably reduced trouble of mold-deposit and is improved in thermal stability.

### BACKGROUND ART

Polyarylene sulfide (hereinafter referred to simply as “PAS”) resins represented by polyphenylene sulfide (hereinafter referred to simply as “PPS”) resins have high heat resistance, mechanical properties, resistance to chemicals, dimensional stability, and fire-retardancy. Owing to these advantageous characteristics, PAS resins are widely used in the materials for electric and electronic parts, for automobile equipment parts, for chemical equipment parts, and the like. Since, however, PAS resins generate a large volume of gas in injection molding stage, they have inherent drawbacks of generation of many mold-deposits and increased frequencies of mold maintenance.

A known method to solve the problems is to filter and wash the polymer product using a specific organic solvent, (JP-A 2-163125, for example). An investigation given by the inventors of the present invention, however, has revealed that the known method not necessarily suppresses the generation of gas, though the method reduces the quantity of oligomer, thereby failing in performing the effect of reducing mold-deposit to fully satisfy the market need.

Addition of various stabilizers to resins was also adopted by known methods for solving the problems. An example is the method to add potassium carbonate or mild magnesium carbonate to a PAS resin, (JP-A 3-199261). According to an investigation of the inventors of the present invention, however, the method cannot attain satisfactory effect of suppressing mold-deposit, and induces additional problems such as deterioration of mechanical strength, thus failing to fully solve the problems in view of practical use.

### DISCLOSURE OF THE INVENTION

A purpose of the present invention is to solve the above problems of related art and to provide a PAS resin composition which can be molded with remarkably reduced troubles of mold-deposit and is improved in thermal stability.

To solve the above problems, the inventors of the present invention conducted detail study and found that the use of a specific PAS resin containing a reduced quantity of nitrogen element provides a PAS resin composition which can be molded with remarkably reduced trouble of mold-deposit and is improved in thermal stability, thus perfected the present invention.

That is, the present invention provides a polyarylene sulfide resin composition which contains:
(A) 100 parts by weight of a polyarylene sulfide resin having a nitrogen element content of 0.55 g or less per 1 kg of the resin; and
(B) 5 to 400 parts by weight of an inorganic filler.

The polyarylene sulfide resin having a nitrogen element content of 0.55 g or less per 1 kg of the resin, as described above, is obtained by, for example, a manufacturing method having the steps of (1) and (2) given below. The method for manufacturing the polyarylene sulfide resin composition has the steps of: (1) dehydrating step including incorporating an organic amide solvent and a sulfur source containing an alkali metal hydrosulfide into a reaction vessel, then heating the mixture thereof to remove at least one part of a water-containing distillate from the system of the mixture; and
(2) polymerizing step including mixing the mixture left in the system after the dehydrating step with a dihaloaromatic compound to prepare a polymerization mixture, and heating the polymerization mixture to polymerize the sulfur source with the dihaloaromatic compound, while adding an alkali metal hydroxide continuously or intermittently to the polymerization mixture to control the pH of the polymerization mixture to the range of 7-12.5 during the course of the polymerizing step.

It is preferable that, in the process fo producing the the polyarylene sulfide resin composition, an adequate part of the total amount of an alkali metal hydroxide is added to a reaction vessel, before heating, of the hydrating step and then the remainder of the alkali metal hydroxide is added to the reaction continuously or intermittently to the polymerization mixture in the polymerization step.

### DETAILED DESCRIPTION OF THE INVENTION

The structural components of the present invention are described below in detail. The PAS resin is a polymer formed by main repeating units of —(Ar—S)—, (where Ar denotes an arylene group). Although the (A) component according to the present invention may be a PAS resin having a generally known molecular structure, it is essential that the (A) component contains 0.55 g or less of nitrogen element per 1 kg of the resin.

Applicable arylene group includes p-phenylene group, m-phenylene group, o-phenylene group, substituted phenylene group, p,p′-diphenylene sulfone group, p,p′-biphenylene group, p,p′-diphenylene ether group, p,p′-diphenylene carbonyl group, and naphthalene group.

The PAS resin applied to the present invention may be a homopolymer structured only by the above-described repeating unit or, is preferably, in some cases, a copolymer containing the following-described repeating units of different kinds in view of workability or other processing characteristics.

A particularly preferred homopolymer is the one (PPS) containing the repeating unit of p-phenylene sulfide group using p-phenylene group as the arylene group. An applicable copolymer includes the one that applies combination of two or more of different kinds among arylene sulfide groups structured by above-described arylene group, and a particularly preferred combination is that of p-phenylene sulfide group with m-phenylene sulfide group. As of these copolymers, the one containing 70% by mole or more of p-phenylene sulfide group, preferably 80% by mole or more thereof is suitable from the point of heat resistance, moldability, mechanical properties, and other physical properties. A preferred copolymer preferably contains m-phenylene sulfide group by 5 to 30% by mole, more preferably 10 to 20% by mole. In this case, the copolymer containing the repeating unit of the component in block pattern (for example, the one disclosed in JP-A 61-14228), rather than in random pattern, shows superior workability and superior heat resistance and mechanical properties, thus that type of copolymer is favorable in use. Among these PAS resins, a polymer having substantially linear-chain structure, obtained by polycondensation of monomers having major component of a bifunctional holoaromatic compound is particularly preferable in use.

That type of linear-chain PAS resin substantially free from branched portions is a suitable target resin in view of the object of the invention owing to the excellent flowability and mechanical properties.

Other applicable polymers than the linear-chain PAS resin include: the one which is prepared by polycondensation to form a partially-branched or crosslinked structure applying a small amount of monomer such as a polyhaloaromatic compound having three or more halogen-substitution groups; the one which is prepared by heating a low molecular weight linear-chain polymer to a high temperature under the presence of oxygen or the like, thereby inducing oxidation crosslinking or thermal crosslinking to increase the melt viscosity, thus to improve the moldability; or a mixture thereof.

The PAS resin as a base resin according to the present invention, including the case of above mixture system, preferably has the melt viscosities (at 310° C. and 1200 sec⁻¹ of shear rate) from 10 to 500 Pa.s. In particular, the PAS resin having the viscosities from 20 to 300 Pas.s is particularly preferable owing to better balance of mechanical properties and flowability. The PAS resin giving lower melt viscosity than the above-range is unfavorable because of the insufficient mechanical strength, while the PAS resin exceeding 500 Pa.s of melt viscosity gives poor flowability of the resin composition during injection molding, resulting in difficulty in molding work, both of which cases are therefore not preferable.

The nitrogen element content of PAS resin is 0.55 g or less per 1 kg of resin, preferably 0.4 g or less. An excess nitrogen element content suggests that the PAS resin contains a large amount of residual N-methyl-2-pyrrolidone (NMP), sodium methylamino butanate, chlorophenylmethylamino butanoic acid, methylaminobutanoic acid group at PAS terminal, or the like. Thermal decomposition of those residual compounds presumably induces frequent generation of mold-deposit during molding, which leads to the necessity of frequent maintenance works on molds, or raises a problem of reduced thermal stability of the obtained PAS resin composition.

The nitrogen element content in the PAS resin can be determined by a known procedure using a commercially available device such as trace nitrogen and sulfur analyzer.

Although the manufacturing method for the PAS resin used in the present invention is not specifically limited if only the PAS resin contains nitrogen element by 0.55 g or less per 1 kg of the resin, a method having the steps of (1) and (2) described below maybe applied to manufacture the PAS resin:
(1) dehydrating for putting an organic amide solvent, a sulfur source containing an alkali metal hydrosulfide, and optionally an adequate part of the total amount of an alkali metal hydroxide in a reaction vessel, then heating the mixture thereof to remove at least one part of a water-containing distillate from the system of the mixture; and
(2) polymerizing for mixing the mixture left in the system after the dehydrating step with a dihaloaromatic compound to prepare a polymerization mixture, and heating the polymerization mixture to polymerize the sulfur source with the dihaloaromatic compound, while adding the remainder of the alkali metal hydroxide continuously or intermittently to the polymerization mixture to control the pH of the polymerization mixture to the range of 7-12.5 during the course of the polymerizing step.

The PAS resin according to the present invention requires only the above range of the nitrogen element content, and the PAS resin may be a blend of a PAS resin containing a large amount of nitrogen and a PAS resin containing a small amount thereof if only the resulting resin satisfies the above condition of the nitrogen element content.

The (B) inorganic filler according to the present invention is an important component to attain satisfactory mechanical strength, though the kind thereof is not specifically limited. Applicable inorganic fillers in powder or granule shape, plate-like shape, and hollow shape include: calcium carbonate such as precipitated calcium carbonate, ground or finely powdered calcium carbonate and special calcium-based filler; nephelite; syenite fine powder; fired clay such as montmorillonite and bentonite; silane-modified clay (aluminum silicate powder); talc; silica (silicon dioxide) powder such as fused silica powder and crystalline silica powder; compound containing silicic acid, such as diatom earth and silica sand; pulverized natural mineral such as pumice powder, pumice balloon, slate powder, and mica powder; an aluminum-containing compound such as alumina, alumina colloid (alumina sol), alumina white and aluminum sulfate; mineral such as barium sulfate, lithopone, calcium sulfate, molybdenum disulfide, and graphite; glass-based filler such as glass bead, glass flake, and foam glass bead; fly ash ball, volcanic glass hollow body, synthesized inorganic hollow body, monocrystal potassium titanate, carbon nanotube, carbon hollow body, carbon 64 fullerene, anthracite powder, artificial cryolite, titanium oxide, magnesium oxide, basic magnesium, dolomite, potassium titanate, calcium sulfite, mica, asbestos, calcium silicate, and molybdenum sulfide.

Examples of the fibrous inorganic filler are glass fiber, asbestos fiber, carbon fiber, silica fiber, silica-alumina fiber, potassium titanate fiber, boron fiber, carbon fiber, and silicon carbide fiber.

The content of (B) component is 5 to 400 parts by weight to 100 parts by weight of PAS resin as the (A) component, and preferably 10 to 250 parts by weight. An excessively small content of the (B) component fails to attain satisfactory mechanical strength, and an excessively large content thereof reduces moldability, thermal stability, and mechanical strength, both of which are unfavorable.

The PAS resin composition according to the present invention may further contain, according to need, various other thermoplastic resins, organic fillers, and other additives within a range not to deteriorate the properties of the PAS resin.

Applicable other thermoplastic resins include: polyphenylene ether, polyether sulfone, polysulfone, polycarbonate, and polyacetal; an ester-group resin such as liquid crystalline polymer, aromatic polyester, polyallylate, polyethylene terephthalate, and polybutylene terephthalate; an olefin-group resin such as polyethylene, polypropylene, and poly-4-methylpentene-1; an amide-group resin such as nylon 6, nylon 66, and aromatic nylon; and a cyclic olefin resin such as polymethyl(meth)acrylate, polyacrylonitrile styrene (AS resin), polystyrene, and norbornene resin.

The olefin-group resin used as other thermoplastic resin may be a polyolefin having reactive functional group or an olefin-based copolymer. That type of polyolefin resin includes polyethylene, polypropylene, polybutene, and various ethylene/propylene groups. Applicable reactive functional group includes an acid anhydride group, glycidyl group, and carboxyl group. Among them, a copolymer of α-olefin and glycidyl ester of α,β-unsaturated acid is preferred. A preferable α-olefin is ethylene. The glycidyl ester of α,β-unsaturated acid may be glycidyl acrylate, glycidyl methacrylate, and glycidyl ethacrylate. As of these, glycidyl methacrylate is preferred. The polyolefin may be a copolymer containing 40% by weight or less of other unsaturated monomer such as vinylether, vinylacetate, vinylpropionate, methyl(meth)acrylate, ethylacrylate, butylacrylate, acrylonitrile, and styrene.

Applicable fillers include polyethylene fiber, polypropylene fiber, polyester fiber, polyamide fiber, fluorofiber, polyaramid fiber, ebonite powder, thermosetting resin hollow ball, thermosetting resin filler, epoxy resin filler, silicone-based filler, Saran hollow ball, shellac, wood powder, cork powder, polyvinylalcohol fiber, cellulose powder, and wood pulp.

Other additives are not specifically limited if only they are commonly used for thermoplastic resin materials. Examples of other additives are antioxidant, ultraviolet absorber, light stabilizer, near-ultraviolet absorber, coloring matter such as dye and pigment, lubricant, plasticizer, antistatic agent, fluorescent brightening agent, and fire-retardant.

To improve the resistance to flash-generation, a silane compound may be added to the resin within a range not to deteriorate the effect of the present invention. Applicable silane compound includes vinylsilane, methacryloxysilane, epoxysilane, aminosilane, and mercaptosilane. Examples of the silane compound are vinyltrichlorosilane, γ-methacryloxypropyl trimethoxysilane, γ-glycidoxypropyl trimethoxysilane, γ-aminopropyl triethoxysilane, and γ-mercaptopropyl trimethoxysilane, though they do not limit the applicable kinds of the silane compounds.

The resin compound according to the present invention is prepared by blending the above components if necessary. The method for blending them is not specifically limited if only they are fully dispersed in the resin. For example, melt-kneading these components in a mixer, a twin shaft kneader, a roll, a Bravender, or a single or twin screw extruder. The most preferable one in view of productivity is to knead and extrude the components in a molten state using an extruder, and then cut to an adequate length to form pellets. The temperature for melting and kneading the components is higher than the melting points of the resin components by 5° C. to 100° C., preferably 10° C. to 60° C.

The PAS resin composition according to the present invention can be molded by injection molding, injection-compression molding, compression molding, blow molding, and the like. Applications of the molded article according to the present invention include materials of electric and electronics equipment parts, materials of automobile equipment parts, materials of chemical equipment parts, and materials of water-section equipment parts.

### BRIEF DESCRIPTION OF THE DRAWING

FIG. 1 is a schematic of the molded article for evaluating mold-deposit and illustrates the evaluating state in the examples.

### EXAMPLES

The present invention is described below in more detail referring to the examples and the comparative examples. However, these examples and comparative examples do not limit the scope of the present invention. The materials of (A) and (B) applied to the examples and the comparative examples are the following.

(A) PAS Resin

(A-1)

To a 20 L autoclave, 5700 g of N-methyl-2-pyrrolidone (NMP) was charged. After establishing a nitrogen atmosphere in the autoclave, the contents were heated to 100° C. in about 1 hour while stirring the contents at 250 rpm of agitator speed. When the temperature of contents reached 100° C., there were added 1170 g of aqueous solution of NaOH (a concentration of 74.7% by weight), 1990 g of aqueous solution of sulfur source (containing 21.8 mole of NaSH and 0.50 mole of Na₂S), and 1000 g of NMP. The mixture was gradually heated to 200° C. in about 2 hours, thereby discharging 945 g of water, 1590 g of NMP, and 0.31 mole of hydrogen sulfide from the reaction system.

After completing the above dehydration step, the contents were cooled to 170° C., then 3283 g of p-dichlorobenzene, 2800 g of NMP, 133 g of water, and 23 g of NaOH (a concentration of 97% by weight) were added. The mixture became 130° C. and pH 13.2. Successively the mixture was heated to 180° C. in 30 minutes while being stirred at 250 rpm of agitator speed, further the mixture was heated from 180° C. to 220° C. in 60 minutes. After letting the mixture react at 220° C. for 60 minutes, the mixture was heated to 230° C. in 30 minutes, and then the mixture was brought to react at 230° C. for 90 minutes to perform the primary polymerization.

Immediately after completing the primary polymerization, the agitator speed was increased to 400 rpm, and 340 g of water was charged to the autoclave under pressure. Once the water was charged, the contents were heated to 260° C. in 1 hour, and then the contents were brought to react at 260° C. for 5 hours to perform the secondary polymerization. The pH of the contents at the end of the secondary polymerization was 10.1.

After completing the secondary polymerization, the reaction mixture was cooled to near room temperature. The mixture was filtered by a 100 mesh screen to separate granule polymer, which was then washed with acetone for 3 times, with water for 3 times, with 0.3% acetic acid for 1 time, and then with water for 4 times, thereby obtaining the washed granule polymer. The granule polymer was dried at 105° C. for 13 hours. Thus obtained granule polymer showed 140 Pas.s of melt viscosity (at 310° C. and 1200 sec⁻¹ of shear rate). The above steps were repeated for five cycles to obtain a necessary quantity of polymer.

(A-2)

To a 20 L autoclave, 5700 g of N-methyl-2-pyrrolidone (NMP) was charged. After establishing a nitrogen atmosphere in the autoclave, the contents were heated to 100° C. in about 1 hour while stirring the contents at 250 rpm of agitator speed. When the temperature of contents reached 100° C., there were added 1990 g of aqueous solution of sulfur source (containing 21.9 mole of NaSH and 0.4 mole of Na₂S), and 1000 g of NMP. The mixture was gradually heated to 200° C. in about 2 hours, thereby discharging 729 g of water, 1370 g of NMP, and 0.70 mole of hydrogen sulfide from the reaction system.

After completing the above dehydration step, the contents were cooled to 170° C., then 3236 g of p-dichlorobenzene and 2800 g of NMP were added. The temperature of mixture reached 130° C. After heating the mixture to 180° C. in 30 minutes, the addition of sodium hydroxide (NaOH) was begun to control pH in the polymerization system to the range from 11.5 to 12.0. Successively, the mixture was heated to 180° C. in 30 minutes while being stirred at 250 rpm of agitator speed, and further heated from 180° C. to 220° C. in 60 minutes. After letting the mixture react at 220° C. for 60 minutes, the mixture was heated to 230° C. in 30 minutes, and then the mixture was brought to react at 230° C. for 90 minutes to perform the primary polymerization.

Throughout the primary polymerization, 1180 g of aqueous solution of NaOH (a concentration of 73.7% by weight) was continuously added to the reaction system using a pump to keep the pH of the polymerization system in the range from 11.5 to 12.0.

Immediately after completing the primary polymerization, the agitator speed was increased to 400 rpm, and 340 g of water was charged to the autoclave under pressure. Once the water was charged, the contents of autoclave were heated to 260° C. in 1 hour, and then the contents were brought to react at 260° C. for 4 hours to perform the secondary polymerization. The pH of the contents at the end of the secondary polymerization was 10.0.

After completing the secondary polymerization, the reaction mixture was cooled to near room temperature. The mixture was filtered by a 100 mesh screen to separate granule polymer, which was then washed with acetone for 3 times, with water for 3 times, with 0.3% acetic acid for 1 time, and then with water for 4 times, thereby obtaining the washed granule polymer. The granule polymer was dried at 105° C. for 13 hours. Thus obtained granule polymer showed 151 Pa.s of melt viscosity (at 310° C. and 1200 sec⁻¹ of shear rate). The above steps were repeated for five cycles to obtain a necessary quantity of polymer.

(B) Inorganic Filler

(B-1)

Glass fiber: 13 μm dia. chopped strand (ECS03T-717, manufactured by Nippon Electric Glass Co., Ltd.)

(B-2)

Glass bead: EGB053Z-A, manufactured by Toshiba Barotini Co., Ltd.)

(B-3)

Calcium carbonate: Whiten P-30, manufactured by Toyo Fine Chemical Co., Ltd.

The evaluation methods applied to the examples and the comparative examples are the following.

[Method for Analyzing Nitrogen Element Content]

The nitrogen element content in the PAS resin was determined by a trace nitrogen and sulfur analyzer (ANTEK 7000, manufactured by ANTEK Co., Ltd.) The working curve for nitrogen was drawn using a solution of triphenylamine in ethylbenzene.

The analysis showed that the PAS resin (A-1) prepared by the above procedure contained nitrogen element by 850 ppm (0.850 g per 1 kg of resin), and the PAS resin (A-2) contained nitrogen element by 320 ppm (0.320 g per 1 kg of resin).

[Evaluation of Mold-Deposit]

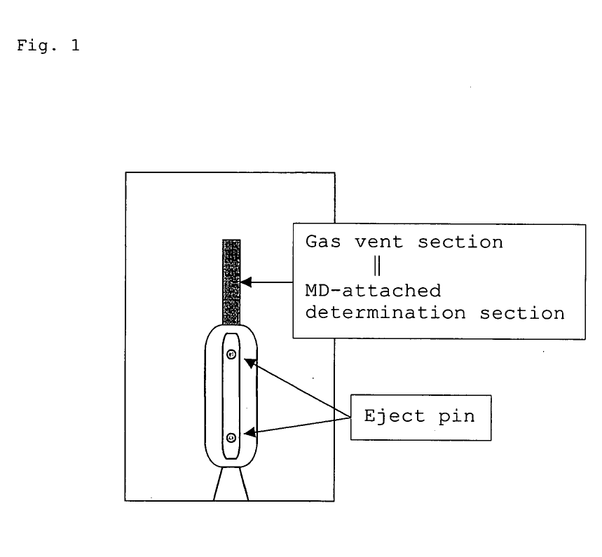

Molded articles having special a shape shown in FIG. 1 were successively formed under the condition given below using an injection molding machine to evaluate the quantity of mold-deposit. That is, 500 pieces of specimens were successively formed by injection-molding, and the mold-deposits attached to the gas-vent section (only on the working side) were collected to weigh them, (μg).

(Molding Condition)

Injection molding machine: Toshiba IS30FPA (Toshiba Machine Co., Ltd.)
Cylinder temperature: 315-320-305-290° C.
Injection pressure: 74 MPa
Injection rate: 1 m/min
Injection time: 2 sec
Cooling time: 5 sec
Molding cycle: 12 sec
Mold temperature: 60° C.
   [Evaluation of Thermal Stability]

A specimen (10 mm in width and 4 mm in thickness) per IS03167 was molded, and the tensile strength (initial value) of the specimen was determined per IS0527-1,2. On the other hand, a specimen molded in a similar method was allowed to stand in an oven at 200° C. for 500 hours, which was then tested to determine the tensile strength (500 h treated value).

The value (percentage) of the tensile strength (500 h treated value) divided by the tensile strength (initial value) was defined as the “tensile strength holding rate” after 200° C. and 500 h treatment, which value was selected as an index of thermal stability. A larger value of tensile strength holding rate means higher thermal stability.

### Examples 1 to 6, Comparative Examples 1 to 3

The respective (A) components shown in Table 1 were preliminarily blended in a Henshel mixer for 5 minutes, (this step was eliminated in the case of only one component). Furthermore, the (B) components were added to the (A) components by the amount given in Table 1. The mixture was blended for 2 minutes, which was then charged to a twin screw extruder at a cylinder temperature of 320° C., thereby obtaining pellets of polyphenylene sulfide resin composition. Thus prepared pellets were tested to evaluate the mold-deposit and the thermal stability applying the above methods.

The results are given in Table 1.

TABLE 1

| | | | | | Nitrogen | Inorganic | | Inorganic | | | |
|---|---|---|---|---|---|---|---|---|---|---|---|
| | PAS-1 | | PAS-2 | | element | filler-1 | | filler-2 | | Mold- | Tensile |
| | | Parts by | | Parts by | content in | | Parts by | | Parts by | deposit | strength holding |
| | Kind | weight | Kind | weight | PAS (g/kg) | Kind | weight | Kind | weight | (μg) | rate (%) |
| Ex. 1 | — | — | A2 | 100 | 0.32 | B1 | 10 | — | — | 9 | 92 |
| Ex. 2 | A1 | 20 | A2 | 80 | 0.43 | B1 | 67 | — | — | 8 | 74 |
| Ex. 3 | A1 | 30 | A2 | 70 | 0.48 | B1 | 30 | B2 | 30 | 10 | 74 |
| Ex. 4 | — | — | A2 | 100 | 0.32 | B1 | 100 | B2 | 100 | 7 | 96 |
| Ex. 5 | — | — | A2 | 100 | 0.32 | B1 | 100 | B3 | 100 | 8 | 96 |
| Ex. 6 | — | — | A2 | 100 | 0.32 | B1 | 67 | — | — | 7 | 76 |
| Com. | A1 | 100 | — | — | 0.85 | B1 | 67 | — | — | 16 | 67 |
| Ex. 1 | | | | | | | | | | | |
| Com. | A1 | 100 | — | — | 0.85 | B1 | 30 | B2 | 30 | 15 | 65 |
| Ex. 2 | | | | | | | | | | | |
| Com. | A1 | 70 | A2 | 30 | 0.69 | B1 | 100 | B3 | 100 | 17 | 96 |
| Ex. 3 | | | | | | | | | | | |

1. A polyarylene sulfide resin composition comprising
(A) 100 parts by weight of a polyarylene sulfide resin having a nitrogen element content of 0.55 g or less per 1 kg of the resin; and
(B) 5 to 400 parts by weight of an inorganic filler.

2. The polyarylene sulfide resin composition as in claim 1, wherein said (A) polyarylene sulfide resin or a part thereof is a polyarylene sulfide resin manufactured by a manufacturing method comprising the steps of (1) and (2):
(1) dehydrating step comprising incorporating an organic amide solvent and a sulfur source containing an alkali metal hydrosulfide into a reaction vessel and then heating the mixture thereof to remove at least one part of a water-containing distillate from the system of the mixture; and
(2) polymerizing step comprising mixing the mixture left in the system after the dehydrating step with a dihaloaromatic compound to prepare a polymerization mixture and heating the polymerization mixture to polymerize the sulfur source with the dihaloaromatic compound, while adding an alkali metal hydroxide continuously or intermittently to the polymerization mixture to control the pH of the polymerization mixture within the range of 7-12.5 during the course of the polymerizing step.

3. The polyarylene sulfide resin composition as in claim 2, wherein an adequate part of the total amount of an alkali metal hydroxide is added to a reaction vessel, before heating, of the hydrating step and the remainder of the alkali metal hydroxide is added to the reaction continuously or intermittently to the polymerization mixture.

4. A molded article obtained by molding the polyarylene sulfide resin composition according to claim 1.

5. A molded article obtained by molding the polyarylene sulfide resin composition according to claim 2.
